(19) United States
(12) Patent Application Publication
(10) Pub. No.: US 2017/0088312 A1
(43) Pub. Date: Mar. 30, 2017

(54) PRE-FORMED FLEXIBLE PACKAGING POUCH AND METHOD FOR MANUFACTURING THE SAME

(71) Applicant: TEMPO PLASTICS LIMITED, Innisfil (CA)

(72) Inventor: Leonardo Alessandro GIGLIO, Bradford (CA)

(21) Appl. No.: 14/869,162

(22) Filed: Sep. 29, 2015

(51) Int. Cl. B65D 30/22; B31B 29/60; B65D 33/24; B65D 30/08; B65D 75/00

(52) U.S. Cl. CPC B65D 31/12; B65D 31/04; B65D 75/008; B65D 33/24; B31B 29/60; B31B 2221/20

(57) ABSTRACT

Described herein are embodiments of a pre-formed flexible packaging pouch comprising multiple compartments for storing products. This flexible packaging pouch permits conflicting products, not traditionally packaged together to be sold as one complete, light-weight, flexible unit.

### TECHNICAL FIELD

The following relates generally to pre-formed flexible packaging pouches, and more specifically to a pre-formed stand-up flexible packaging pouch comprising multiple compartments.

### BACKGROUND

Due to its versatility, pre-formed flexible packaging pouches represent a growing segment of the packaging industry. Pre-formed flexible packaging pouches may be designed to stand up once sealed and filled with product by providing a gusset, folded up between the front and back panels of the pouch. Various types of products can be stored in flexible packaging pouches including liquid and dry goods, depending on types of materials and seals used in manufacture of a given pouch.

Pre-formed flexible packaging pouches may be used in the medical packaging industry in order to safeguard goods during transport.

### SUMMARY

In one aspect, a pre-formed packaging pouch formed from a film is provided, the pouch comprising: a face portion and a back portion disposed in opposed relationship; a sealed section for sealing the face portion and the back portion comprising: a pair of longitudinal end seals disposed along opposite longitudinal edges of the pouch; and a longitudinal separating seal disposed between the pair of end seals, the separating seal defining a pair of compartments formed by the face portion and the back portion.

In another aspect, a method of manufacturing a pre-formed packaging pouch, the method comprising: receiving a span of flexible packaging material; trimming the span of flexible packaging material to provide a packaging film comprising a longitudinally disposed face portion and back portion; folding the face portion and back portion to be in an opposed relationship; sealing the face portion to the back portion along a sealed section, the sealed section comprising: a pair of longitudinal end seals disposed along opposite longitudinal edges of the film; and a longitudinal separating seal disposed between the pair of longitudinal seals, the separating seal defining a pair of compartments formed by the face portion and the back portion.

These and other aspects are contemplated and described herein. It will be appreciated that the foregoing summary sets out representative aspects of systems and methods to assist skilled readers in understanding the following detailed description.

### DESCRIPTION OF THE DRAWINGS

A greater understanding of the embodiments will be had with reference to the Figures, in which:

FIG. 1 illustrates a dieline for a pre-formed flexible packaging pouch;

FIG. 2 illustrates a method of manufacturing a flexible packaging pouch comprising multiple compartments;

FIG. 3 illustrates a side view of a flexible packaging pouch;

FIG. 4 illustrates a front perspective view of a flexible packaging pouch comprising multiple compartments;

FIG. 5 illustrates a bottom view of a flexible packaging pouch comprising multiple compartments;

FIG. 6 illustrates a dieline of a further pre-formed flexible packaging pouch;

FIG. 7 illustrates the flexible packaging pouch of FIG. 6, drawn to an example scale; and

FIG. 8 illustrates a further pre-formed flexible packaging pouch.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

There are instances where it is desirable to package multiple products together, while maintaining separation between the products. Currently, to accomplish this, offline modifications are made to flexible packaging pouches by physically altering machine-made pouches by hand. This may, for example, be to add a second compartment, or to somehow join a first package to a second package. Alternatively, a wasteful solution of placing two independent packages within one larger package is used. In any of these instances, high costs, including labour costs may result. Further, the structural integrity of these solutions may be compromised by any of the alterations.

The following provides a pre-formed flexible packaging pouch comprising multiple compartments for storing and transferring products, such as valuable or sensitive materials, or food products. “Pre-formed” pouches are those that can be manufactured in a separate manufacturing process to filling with material, and can be contrasted with “form filled” pouches, which are formed as part of, or contemporaneously with, the filling process.

The pouch is formed from a unitary piece of laminate and comprises a sealed section between compartments. Sealed sections of the pouch may be provided with a monolayer or multilayer laminated film. The specific layers of film can be selected as appropriate for the intended use of the pouch; for example, certain solids and liquids are best stored using particular container materials (metals, plastics, etc.), and the layers may comprise these materials.

Each compartment may be provided with a closure feature, such as a press to close fastener. Further, a heat seal may be provided at a top edge of the pouch to close each compartment; in this case, the heat seal will be made following filling of the containers.

The pre-formed unclosed pouch can be provided to a filling process for later addition of material to the compartments. It will be appreciated that due to the pre-formed nature of the pouch, different contents can be placed within each container. The pre-formed pouch thus permits conflicting ‘non-analogous’ products, not traditionally packaged together, to be sold as one complete, light-weight, flexible unit. For example, liquids and powders can be packaged together. Further, foods which may otherwise impart their flavor if packaged in the same compartment may be packaged together separately.

The described flexible packaging pouch provides novel marketing opportunities over traditional single compartment pouches. As known to those of skill in the art, flexible packaging often has marketing graphics printed on its outwardly-facing surfaces. The provision of two compartments provides cross-promotion opportunities, such as for items used together but traditionally sold separately. Marketing graphics may be provided for each product, promoting sales of each. Further, functional marketing opportunities are provided, wherein a well-established product may be packaged with a new product. The described pouch may further be advantageous in applications where it is mandatory that products stay separate in their own enclosures during shipping, yet together in one package.

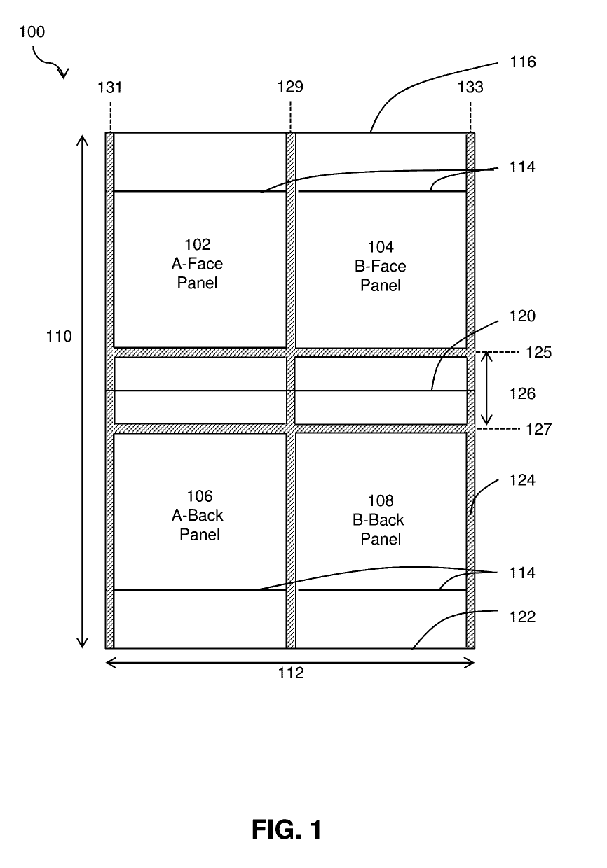

Referring now to FIG. 1, shown therein is a dieline 100 for a film for manufacture into a flexible packaging pouch comprising multiple compartments according to a method 200 described below. The dieline 100 identifies panels 102 and 104 on a face portion of a film, panels 106 and 108 on a back portion of the film, trim lines 116 and 122, sealed sections 124 (shown in hash lines as a grid in FIG. 1), and closure features 114. The dieline further comprises an optional gusset section 126 between lines 125 and 127 providing a gusset for each compartment, and a fold line 120 at the center of the gusset section 126 (and of the dieline), separating the face portion from the back portion of the dieline. During manufacture into a pouch, the monolayer or multilayer film for the pouch is folded along line 120, such that the face portion and back portion face one another (or are opposed, depending on the direction of folding). The term “line” is used for clarity of illustration; in some instances trim lines 116, 122, and lines 120, 125 and 127 may not be visibly manifested on the dieline.

Preferably the flexible packaging pouch is manufactured in-line along a machine direction of a manufacturing process. The unfolded packaging pouch has a dimension 110 along a machine direction, also referred to as the longitudinal direction. The unfolded packaging pouch further has a dimension 112 along a transverse direction.

The dieline comprises A-face panel 102, B-face panel 104 on a face portion of the dieline, and further comprises A-back panel 106 and B-back panel 108 on a back portion of the dieline. Once manufactured into a packaging pouch, the face panels (102, 104) of the face portion, and back panels (106, 108) of the back portion will be provided on face and back sides, respectively (depending on the fold direction), of the packaging pouch. The A face and back panels (102, 106) will be sealed together to provide a first (“A”) compartment. The B face and back panels (104, 108) will be sealed together to provide a second (“B”) compartment. Once manufactured into a pouch, two compartments (A, B) will be provided and disposed in a side-by-side arrangement, separated by intermediate seal line 129. If included, the gusset section 126 provides a separate bottom gusset for each compartment of the pouch.

The dieline for the film comprises trim lines 116 and 122. Preferably, a quantity of film necessary to form a plurality of packaging pouches is longitudinally disposed during a manufacturing process along the machine direction, such that trim lines 116, 122 may be provided between longitudinally disposed pouch sections of the film in order to separate each pouch. Accordingly, trim lines 116, 122 may be shared between subsequent packaging pouches along a machine direction. A trim (i.e. excess packaging material) may be provided between longitudinally spaced packaging pouches and may be removed during trimming.

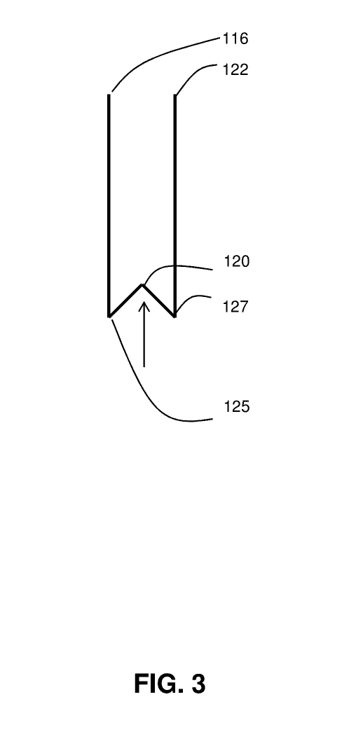

As described above, in some embodiments a gusset section 126 providing gussets for each compartment separates the face and back portions of the film. As shown in FIG. 3, and described in more detail below, during manufacturing, the film may be folded along lines 120, 125 and 127—tucking in the gusset—prior to conducting sealing operations. If no gusset is provided, the film may merely be folded along line 120, and the sealing section will not extend along lines 125 and 127.

The dieline further comprises sealed sections 124 (hashed) indicating the locations of sealing operations during manufacture. Sealing operations may be carried out along the sealed sections (such as along lines 129, 131, 133, and optionally along lines 125, 127) during manufacturing once respective face and back panels of a packaging film are disposed to be facing one another (or opposed, depending on fold direction). If a gusset is included, sealing operations at least along lines 129, 131, 133 may only be conducted once the gusset section is tucked in. Sealing operations along longitudinal line 129 separate the compartments A, B and may provide a leak proof seal.

From FIGS. 3, 4 and 5 illustrating a flexible packaging pouch, it will be appreciated that sealing operations may be applied along lines 125 and 127 to provide a gusset having sealed bottom edges (i.e. without sealing line 125 to line 127). The seals along lines 125 and 127 may be provided for aesthetic and structural purposes. For example, sealing operations along lines 125 and 127, may improve stability of the pouch when standing. Longitudinal sealing (along lines 129, 131, 133) may be carried out subsequently to sealing along lines 125 and 127. In some embodiments, sealing operations may not be conducted along lines 125 and 127, particularly if no gusset is provided.

Sealing operations may include applying heat and mechanical pressure. Further, adhesives, gummed tape and ultrasonic welding may be applied additionally or alternatively to heat sealing. Sealing sections may be provided with a monolayer or multilayer laminated film. The use of a multilayer film with suitable layering may facilitate printing and provides additional barrier options.

The flexible packaging pouch further comprises a closure feature 114 for each panel, which may extend transversely between longitudinal sealed sections, as shown. Example closure features include press-to-close fastener and slider seals. Further example closure features include adhesive strips, and tamper-proof closure features (i.e. void tape/tamper tape). Tamper-proof closure features may show some visible evidence of tampering once opened.

Embodiments comprising tamper-proof closure features may be particularly adapted for the medical packaging industry. Such embodiments may help facilitate better security in the handling and shipping of items, decreasing insurance liabilities. It may further facilitate traceability of medical items against loss of information, a product or sample.

The flexible packaging film may be made of various materials depending on storage requirements. The film may be made from a single laminated sheet of flexible plastic. Further, biodegradable and oxo-degradable materials are contemplated, such as EPI Environmental Products Inc.™ oxo-degradable plastics and compostable films.

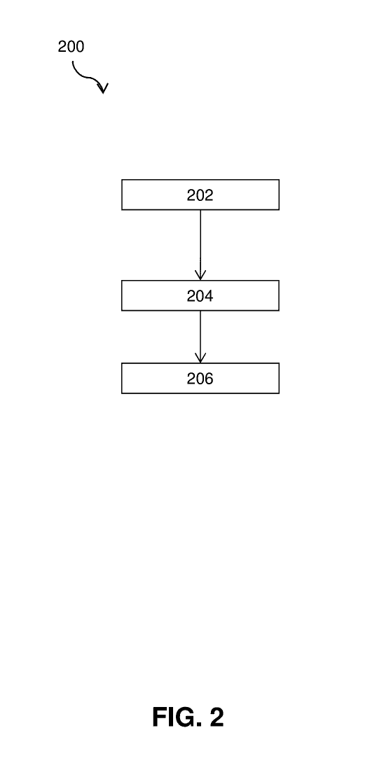

Referring now to FIG. 2, shown therein is a method for manufacturing a flexible packaging pouch comprising multiple compartments. For clarity of illustration, the method is described in relation to the dieline 100 for a film. Preferably the blocks of method 200 are carried out in-line in a manufacturing process.

At block 202, a span of flexible packaging film is manufactured. The span may be extruded, allowed to cool, and rolled prior to further steps of the method being carried out. Optionally, graphics may be printed onto one or both sides of the span according to known techniques, such as flexographic techniques. Graphics may be printed onto the span such that a desired graphic faces outward when a resulting flexible packaging pouch is displayed.

At block 204, the span is received for further manufacturing operations. The film may be trimmed, folded, and sealing operations may be conducted. Trimming operations are carried out along lines 116, 122 in order to trim the film for each pouch, providing separate “blanks” along the machine direction for each flexible packaging pouch. As trim lines 116, 122 may be shared between subsequent pouch films, in some instances a single trimming operation may be carried out. Face and back panels for each compartment (e.g. 102, 106) may be caused to face one another (or oppose one another, depending on folding direction) prior to conducting sealing operations. If a gusset is provided, the gusset may be tucked in before sealing operations, as illustrated in FIG. 3, and the film may be folded along lines 120, 125 and 127. If no gusset is provided, the face and back portions may be otherwise manipulated to face one another, such as by folding along a center dividing line 120, which may subsequently be sealed. Sealing operations may be conducted at illustrated sealed sections 124. Sealing operations may include heat sealing, wherein heat and mechanical pressure may be applied. The thickness of the seal and the sealing technique is dependent on the desired seal strength, which may be determined according to the type of product desired to be contained within each compartment of the finished packaging pouch.

Preferably, a closure feature 114 is provided for each panel 102, 104, 106, 108. It is contemplated that further features may be added to the pouch during manufacturing operations, some of which are described in more detail below. For example, a one-way degassing valve may be added to the at least one panel of each side; the addition of a one-way valve is particularly popular in the coffee industry. Cutouts may be applied in order to provide hanger holds or handles (referred to collectively as perforations). Steam valves may be provided, such that the packaging can be used for microwave and oven cooking methods. Micro and laser perforations may provided, as some products may require higher permeability rates through packaging.

At block 206, once the further manufacturing operations have been completed on each pouch, completed packaging pouches comprising multiple compartments are thereby provided. Further operations may be effected, such as placement of a product in each compartment. Further, once a product is placed within each compartment, a seal may be applied to seal the packaging in proximity to lines 116, 122 (which may thereby be joined). The seal along lines 116, 122 may be provided, for example, if no closure features are provided and the compartments are not required to be reclosable.

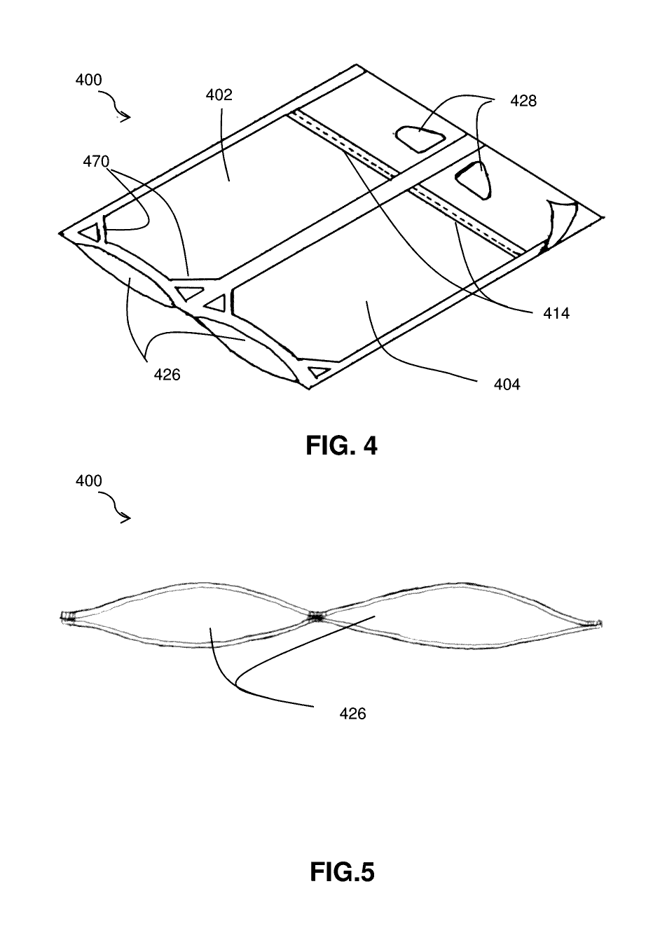

Referring now to FIGS. 4 and 5, shown therein are views of an illustrative packaging pouch 400 comprising multiple compartments. The pouch 400 comprises a first compartment 402, and a second compartment 404. The pouch further comprises handle perforations 428 providing handles, gussets 426 and closure features 414. The illustrated gussets 426 each have diagonal sealed sections 470, analogous to sections 570 described in more detail below. FIG. 5 provides a bottom view of the pouch, illustrating particularly a configuration of gussets 426.

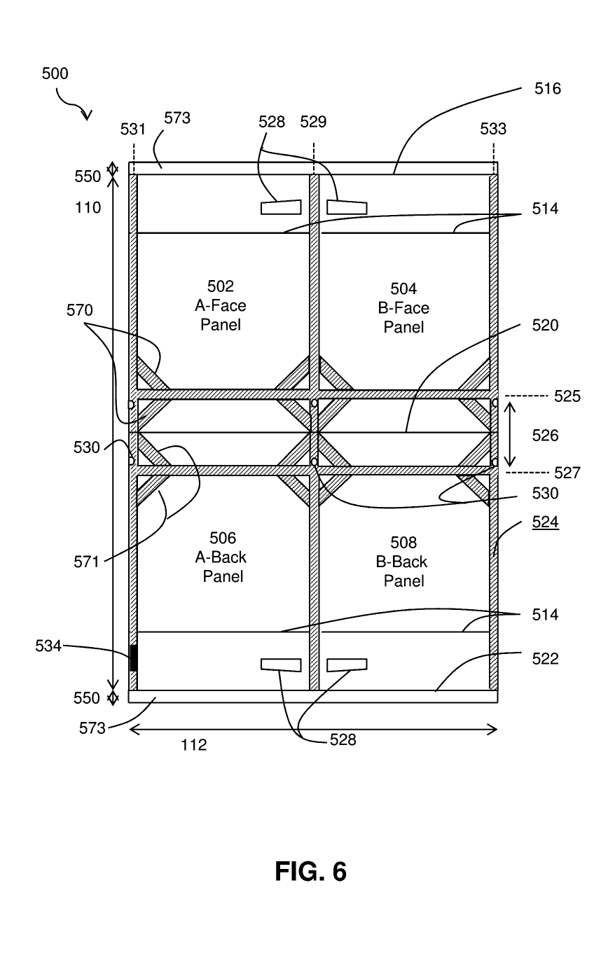

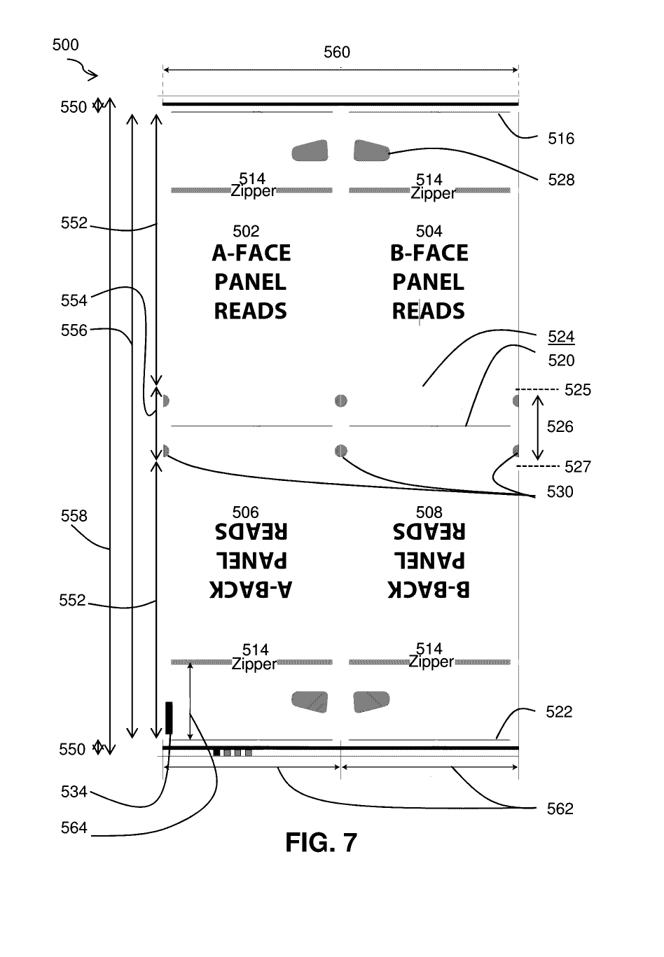

Referring now to FIGS. 6 and 7, shown therein is a dieline 500 for a film for use in manufacturing a packaging pouch comprising multiple compartments, such as the packaging pouch 400.

The dieline 500 comprises panels 502, 504, 506, 508, similarly to the panels of dieline 100. The illustration in FIG. 7 shows that during printing of graphics, the text of the face panels may be inverted as compared to the text of the back panels. The dieline 500 comprises closure features 514, trim lines 516 and 522, and line 520 providing the center of a gusset section 526, and separating the front and back portions of the film. The illustrated gusset section 526 is provided between lines 525 and 527, which are similar to lines 125, 127 described above. The dieline 500 comprises a trim 573 longitudinally disposed from the trim lines 516, 522 toward longitudinal edges of the film.

The dieline 500 comprises handle perforations 528 to provide handles for carrying or hanging the resulting packaging pouch. The dieline 500 may further comprise tack holes 530 within the gusset section 526.

The dieline 500 comprises sealed sections 524 (shown hashed), similarly to sealed section 124 described above. As above, sealing operations may be carried out along lines 529, 531, 533, 525 and 527. The sealed sections 524 further comprise diagonal sections (best shown by element 570 in FIG. 5) disposed to provide sloped corners for compartments of the resulting packaging pouch, facilitating removal of contents. During sealing operations, each mating pair of diagonal sections on a panel, such as pair 570, will be sealed together to provide sloped corners for the compartments. If the gusset section 525 is provided, these sections may be sealed contemporaneously with conducting sealing operations along lines 525, 527, optionally before applying longitudinal seals along lines 529, 531 and 533. In embodiments, sealing operations may instead be conducted such that pairs 570, 571 may be sealed together, which may instead be carried out contemporaneously with applying longitudinal seals. Other shapes of the diagonal sections are contemplated, such as semi-circular sloping sections.

The dieline 500 comprises an eyemark 534 provided along a longitudinal edge of the film. The eyemark may be provided for recognition by a scanning system for use in automatic positioning for pouching equipment. In addition or alternatively to eyemark 534, microdots may be placed on the film, such as along each of lines 516, 522 and 520. Microdots may further be recognized by a scanning system for printing registration. For example, as the film moves longitudinally, scanning and recognition of the microdots along line 520 may indicate a desired midpoint between the face side and back portions.

Referring now to FIG. 7, shown therein is a scale illustration of an embodiment of the dieline 500, provided to illustrate example dimensions. Illustrative dimensions will now be described. Other dimensions are contemplated, and may depend on the shape and size of products desired to be included in a packaging pouch.

Dimension 552 may be about 10.875″. Dimension 554, referring to the width of the gusset section, may be about 3″. Dimension 556, referring to the dimension of finished film to convert, may thus be about 24.75″ (10.875″×2+3″). Dimension 550, referring to the trim, may be about 0.625″ on either longitudinal end of the film. Dimension 558, the film to trim dimension, may thus be about 26″. Dimension 560, a transverse width of the film, may be about 14″. Dimension 562 may be about 7″. The maximum print area may thus be about (6.75″×24.75″)×2. The thickness of the seal may be about ⅜″. Dimension 564, the distance between trim lines 516, 522 and the closure features 514 may be about 3″. The eyemark 534 may measure about 0.25″×1.25″.

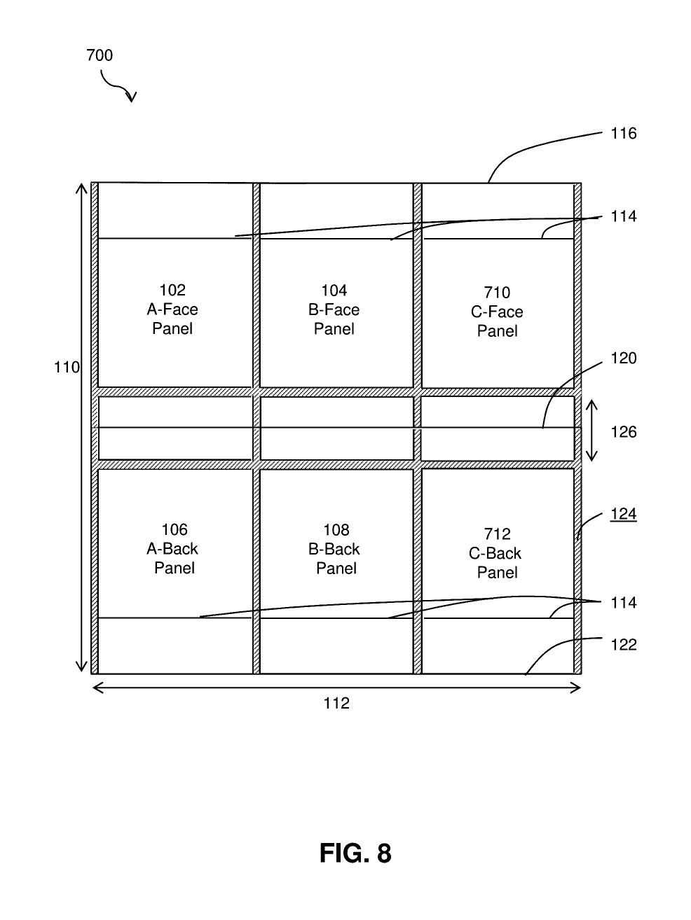

Referring now to FIG. 8, shown therein is an embodiment of a dieline 700 for a film for manufacture into a packaging pouch comprising additional panels 710, 712 providing a third compartment. It will thus be appreciated that, though illustrative embodiments have been described above wherein the packaging pouch comprises two compartments, in alternative embodiments additional compartments may be provided.

Although the foregoing has been described with reference to certain specific embodiments, various modifications thereto will be apparent to those skilled in the art without departing from the spirit and scope of the invention as outlined in the appended claims. For example, though in the embodiments described above, mating face and back panels for each compartment are longitudinally disposed along the machine direction of a film, in some instances, mating face and back panels can be transversely disposed with respect to the machine direction, with necessary modifications to the manufacturing method. Further, though the above described embodiments generally describe gusseted pouches, gussets may not be included; removal of the gusset may affect stability of the pouch during standing and may further require modifications to the manufacturing method. Further, the configurations described above are illustrative. For example, different shapes and sizes for the pouch and compartments are contemplated; each compartment may be differently shaped and sized. The entire disclosures of all references recited above are incorporated herein by reference.

1. A pre-formed packaging pouch formed from a film, the pouch comprising:
a. a face portion and a back portion disposed in opposed relationship;
b. a sealed section for sealing the face portion and the back portion comprising:
i. a pair of longitudinal end seals disposed along opposite longitudinal edges of the pouch; and
ii. a longitudinal separating seal disposed between the pair of end seals, the separating seal defining a pair of compartments formed by the face portion and the back portion.

2. The pouch of claim 1, further comprising a bottom gusset section integrally formed with the face portion and the back portion, and tucked therebetween for providing a gusset for each compartment.

3. The pouch of claim 1, wherein the film is a multilayer film.

4. The pouch of claim 1, wherein the sealed section further comprises a diagonal portion comprising diagonal seals extending diagonally between a bottom edge of each of the face portion and back portion and the longitudinal portion of the sealed section.

5. The pouch of claim 1, further comprising at least one closure feature for use in closing each compartment.

6. The pouch of claim 5, wherein the closure feature comprises a reclosable closure feature.

7. The pouch of claim 6, wherein the re-closable closure feature comprises a press-to-close fastener.

8. The pouch of claim 5, wherein the closure feature comprises a tamper resistant closure feature.

9. The pouch of claim 1, further comprising a third compartment spaced from the second compartment by a second separating seal disposed between one of the end seals and the separating seal.

10. (canceled)

11. (canceled)

12. (canceled)

13. (canceled)

14. (canceled)

15. (canceled)

16. (canceled)

17. (canceled)

18. (canceled)
